(19) United States
(12) Patent Application Publication
(10) Pub. No.: US 2008/0294986 A1
(43) Pub. Date: Nov. 27, 2008

(54) APPARATUS AND METHOD FOR CREATING MACRO

(75) Inventors: Young-Wan SEO, Suwon-si (KR); Sun-Wha CHUNG, Yongin-si (KR); In-Sik MYUNG, Incheon (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD, Suwon-si (KR)

(21) Appl. No.: 11/935,947

(22) Filed: Nov. 6, 2007

(30) Foreign Application Priority Data
May 21, 2007 (KR) 10-2007-0049334

(51) Int. Cl. G06F 3/048

(52) U.S. Cl. 715/704

(57) ABSTRACT

An apparatus and method for creating a macro are provided. The apparatus includes a generation unit generating a user interface (UI) performing a function of a macro command created by combining macro commands corresponding to a plurality of objects, and an output unit displaying the UI on a screen.

### CROSS-REFERENCE TO RELATED APPLICATION

This application claims priority from Korean Patent Application No. 10-2007-0049334 filed on May 21, 2007, in the Korean Intellectual Property Office, the disclosure of which is incorporated herein by reference in its entirety.

### BACKGROUND OF THE INVENTION

1. Field of the Invention

Apparatuses and methods consistent with the present invention relate to creating a macro, and, more particularly, to creating a macro command, by which a plurality of commands corresponding to a user's selected objects are combined and created as a single macro command, thereby enabling the user to perform a predetermined macro command function in an easy, convenient manner without the need to perform a complicated menu-selection procedure.

2. Description of the Related Art

With the development of communication technologies, there has been a rapidly growing demand for mobile terminals, including CDMA (Code Division Multiple Access) or TDMA (Time Division Multiple Access) cellular phones, PCS (Personal Communication Services) compatible phones, GSM (Global System for Mobile Communications) compatible phones, smart phones, WAP (Wireless Application Protocol) compatible phones, and so on.

A mobile terminal generally includes a display panel, e.g., a liquid crystal display (LCD) panel, and is provided with a variety of functions such as SMS (Short Message Service), MMS (Multimedia Message service), call history, e-mail, web access, and supplementary services such as PIMS (Personal Information Management System) or a micropayment system. The PIMS supports various functions including a text-style memo pad function, an anniversary reminder, a business card organizer, an appointment or schedule manager, a calendar, a calculator, and so on.

More multi-functional and diversified mobile terminals result in a very complicated menu structure. In addition, the user may encounter inconvenience in performing a predetermined function due to multiple search steps involved in identifying the function. Particularly, since mobile terminals are used by elderly and/or disabled people, there exists a need to provide users with easy, fast, user-friendly interfaces.

### SUMMARY OF THE INVENTION

The present invention provides an apparatus and method for creating a macro, by which a plurality of commands corresponding to a user's selected objects are combined and created as a single macro command, thereby enabling the user to perform a predetermined macro command function in an easy, convenient manner without the need for performing a complicated menu selection procedure.

The above and other aspects of the present invention will be described in or be apparent from the following description of exemplary embodiments.

According to an aspect of the present invention, there is provided an apparatus for creating a macro, the apparatus including a generation unit which generates a user interface (UI) that performs a function of a macro command created by combining macro commands corresponding to a plurality of objects, and an output unit which displays the UI on a screen.

According to another aspect of the present invention, there is provided a method for forming a macro, the method including generating a user interface (UI) that performs a function of a macro command created by combining macro commands corresponding to a plurality of objects, and displaying the UI on a screen.

### BRIEF DESCRIPTION OF THE DRAWINGS

The above and other features of the present invention will become apparent by describing in detail exemplary embodiments thereof with reference to the attached drawings in which:

FIG. 1 is a conceptual diagram showing the generation of a macro command according to an exemplary embodiment of the present invention;

FIG. 2 shows a screen for generating a macro command according to an exemplary embodiment of the present invention;

FIG. 3 shows a screen on which a macro command is created using a plurality of commands according to an exemplary embodiment of the present invention;

FIG. 4 shows a user interface (UI) for executing a macro command function according to an exemplary embodiment of the present invention;

FIG. 5 shows an execution screen of a macro command according to an exemplary embodiment of the present invention;

FIG. 6 is a conceptual diagram showing the reconstruction of a macro command according to an exemplary embodiment of the present invention;

FIG. 7 is a block diagram of a macro generator according to an exemplary embodiment of the present invention; and

FIG. 8 is a flowchart illustrating a method for creating a macro according to an exemplary embodiment of the present invention.

### DETAILED DESCRIPTION OF EXEMPLARY EMBODIMENTS OF THE INVENTION

Advantages and features of the present invention and methods of accomplishing the same may be understood more readily by reference to the following detailed description of exemplary embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like reference numerals refer to like elements throughout the specification.

Exemplary embodiments of the present invention will hereinafter be described in conjunction with the appended drawings.

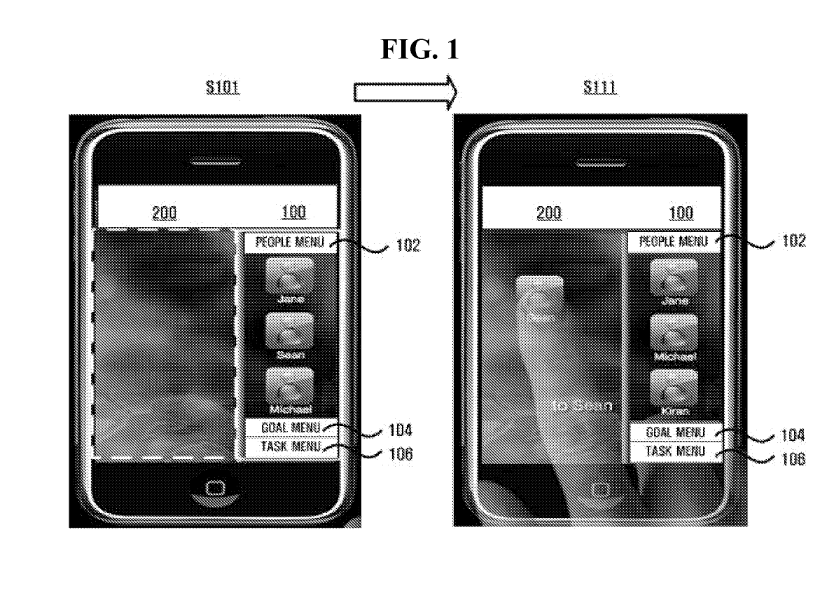

FIG. 1 is a conceptual diagram showing the generation of a macro command according to an embodiment of the present invention.

A first display screen 100 may include a people menu 102, a goal menu 104, and a task menu 106. The people menu 102 is a menu option for selection a target person on whom a user intends to perform a predetermined task, for example, a friend of the user, the goal menu 104 is a menu option for selection an event which the user intends to perform on the target person, for example, a short message service (SMS), and the task menu 106 is a menu option for selecting an action for the event, for example, sending an SMS message. The menu structure is not limited to the illustrated example and the menu may be structured in various ways.

The user selects a predetermined object from each menu displayed on the first display screen 100 in operation S101, and drags the selected object and drops it onto the second display screen 200 in operation S111. Here, the first display screen 100 and the second display screen 200 may be implemented as a touch screen, but are not limited thereto.

The objects having moved to the second display screen 200 may be formed as a set of commands (to be referred to as a macro command hereinafter). In other words, the user may click on a predetermined macro-generating button to create a macro command by combining the commands corresponding to the respective objects having moved to the second display screen 200.

In addition, if the user selects the respective objects from the people menu 102, the goal menu 104 and the task menu 106 displayed on the first display screen 100 and moves the selected objects to the second display screen 200, the commands corresponding to the respective objects are automatically combined and created as a single macro command without the need to click on a macro-generating button.

Here, the second display screen 200 may serve as a macro-command-creating screen. That is, assuming that a command corresponding to a first object is F1, a command corresponding to a second object is F2, and a command corresponding to a third object is F3, a combination of commands, F1+F2+F3, corresponding to the respective objects having been moved to the second display screen 200 are created as a macro command. Here, once the objects moved to the second display screen 200 are sensed, they are automatically created as the macro command.

Meanwhile, if the screen of the present invention is constructed of a single display screen, i.e., the first display screen 100, without the second display screen 200, the commands corresponding to the objects selected from the menus may be created as a single macro command, respectively. In this case, the commands corresponding to the user's selected objects are stored in a storage area and the respective stored commands are created as one macro command in response to an input command of the macro-generating button, which is described in more detail in the following.

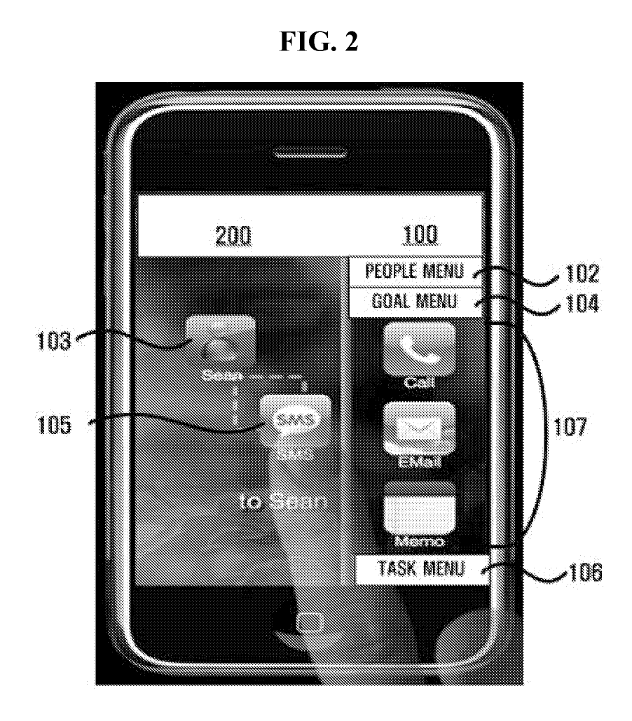

FIG. 2 shows a screen for generating a macro command according to an embodiment of the present invention.

For example, the user intends to generate a macro command to perform a short message service (SMS) to Sean. Conventionally, in order for the user to select a target person of the SMS, a phone book or a recent call history is searched for, an SMS button is pressed, and a “Send” button is then pressed, which is inconvenient as it involves performing repetitive tasks and searching for complicated menu options. By contrast, according to the present invention, the user can attain the desired result in a simplified manner through the created macro command.

As shown in FIG. 2, the first display screen 100 includes the people menu 102, the goal menu 104, and the task menu 106. Here, objects in each menu may be offered in a variety of ways, such as text, images, moving images, or icons. In the following, for explanatory convenience, it is assumed that each object is formed as an icon.

First, the user selects the people menu 102. Then, a list of people may be offered, allowing the user to make a choice. The user selects an object “Sean” 103 and then moves to the second display screen 200. In this embodiment, objects contained in the respective menus are selected sequentially, for example, in the following order: people menu 102->goal menu 104->task menu 106, but the present invention is not limited thereto. The order of menu selection may vary. For example, the objects contained in the respective menus may be selected sequentially in the following order: task menu->goal menu->people menu; or people menu->task menu->goal menu.

Next, the user selects the goal menu 104. Then, a list of events may be offered, allowing the user to make a choice. The list of events may contain Short Message Service (SMS), Write multi-mail, Attach photos, and so on. For example, the user can select the object SMS 105, and then move it to the second display screen 200.

Next, the user selects the task menu 106. Then, a list of functions 107 corresponding to the SMS, which the user has selected from the goal menu 104, is offered. For example, the list of functions 107 corresponding to the SMS may contain Send, Programmed to send, Hold to send, or the like. The user may select Send (not shown) to then move the same to the second display screen 200.

Through the above-described steps, the objects, i.e., Sean 103, SMS 105, and Send (not shown), are displayed on the second display screen 200 in the form of icons to then be offered to the user. In order to create a macro command for the selected objects, the user clicks on the macro command generation button.

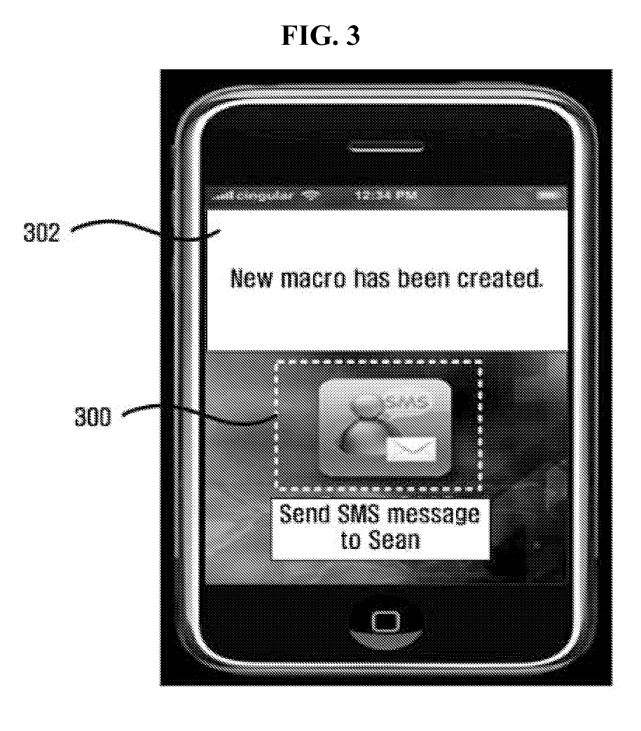

Then, as shown in FIG. 3, commands corresponding to the respective objects on the second display screen 200 are combined as a macro command and displayed as a UI 300 in the form of a single image.

FIG. 3 shows a screen on which a macro command is created using a plurality of commands according to an embodiment of the present invention.

Objects displayed on the second display screen 200 can be represented as an image of the UI 300, which is a combination of commands for creating the macro command. In more detail, sizes of the respective objects, i.e., Sean 103, SMS 105, and Send (not shown), are reduced or shapes thereof are changed, creating a single image. Here, pre-stored images may be used according to the combination of the respective objects.

Then, a message 302 saying that “New macro has been created.” may be displayed to the user.

Thereafter, the user can send easily an SMS message to Sean through the created UI 300, which is described in greater detail in the following.

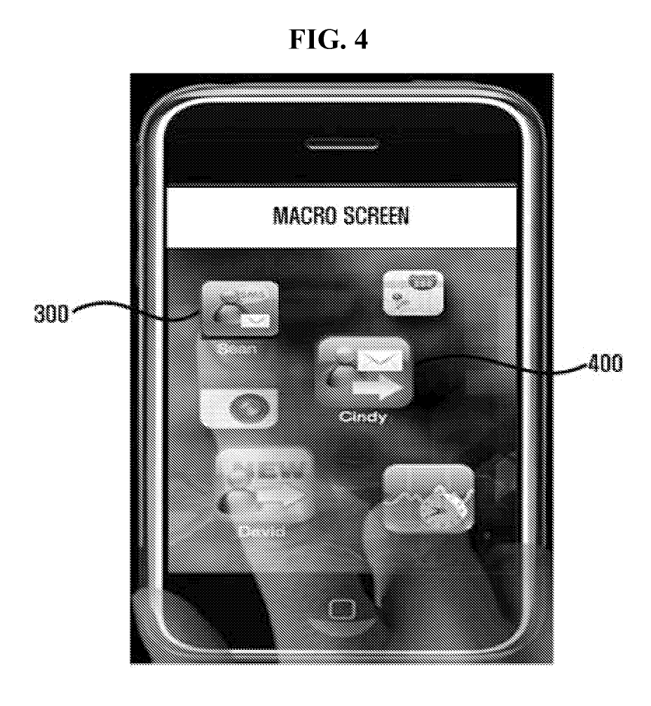

FIG. 4 shows a user interface (UI) for executing a macro command function according to an embodiment of the present invention.

A UI having a predetermined shape may be offered to the user to perform the macro command. Here, the size of the UI may vary according to the frequency of use or the significance level preset by the user. In other words, the size of the UI may vary according to the number of times the UI is clicked on. Of course, the shape and the color of the UI can also vary.

For example, when the user more frequently uses a UI 400 executing a macro command function to send an SMS message to Cindy, and less frequently uses the UI 300 executing a macro command function to send an SMS message to Sean, the UI 400 may be expanded and compared to the UI 300, to then be displayed on the screen.

Accordingly, the user can easily identify the UI that he or she frequently uses, by which the SMS can be more conveniently used.

Meanwhile, at least one of the size, the shape and the color of the UI may be used to determine whether the macro command is feasible. For example, it is assumed that a macro command is composed of commands for real-time chatting with a target person. Here, in a case where the target person is not currently on line, the color of the UI corresponding to the macro command is processed to be tinted with a transparent color, indicating real-time chatting with the target person is not possible. In addition, in a case of a macro command comprised of a combination of commands for providing the user with information about the weather, the weather information changing in real time depending on the weather change is represented by the UI, which will now be described in detail.

As shown in FIG. 4, UIs corresponding to a plurality of macro commands are displayed on a macro screen. The user selects the desired UI among the UIs displayed on the macro screen. When the user selects the UI 300 to send a short message service (SMS) message to a target person, e.g., Sean, a message input window is offered to the user, allowing the user to enter the SMS message to be delivered to Sean.

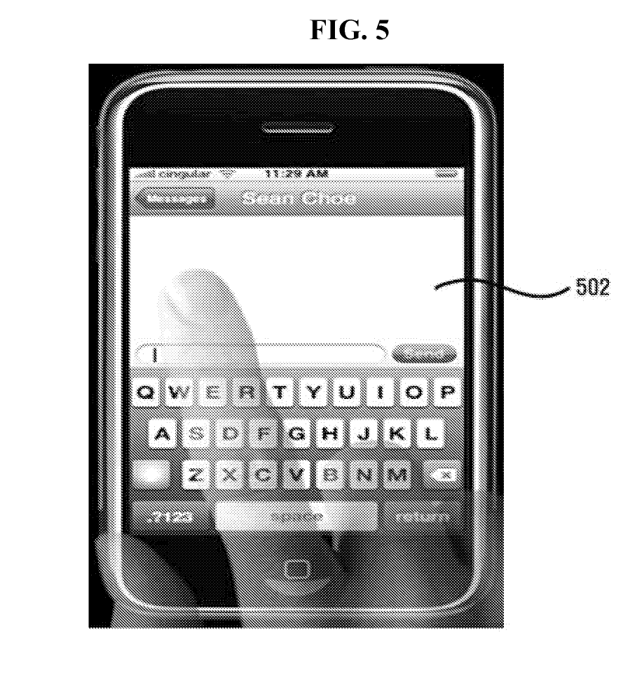

As shown in FIG. 5, if the user enters the content of the SMS message into a message input window 502 and stores it, the SMS message can be immediately delivered to Sean.

Based on this principle, the user is able to send multi-mails to a target person, or a variety of services, such as checking weather information, interactive chatting, or listening to music, can be utilized easily and conveniently, unlike in the prior art in which a complicated procedure of selecting menu options must be performed.

As described above, the construction of the macro command, which is a combination of a plurality of commands, can be changed in various ways. For example, it is assumed that the user intends to send an SMS message to Cindy, instead of Sean.

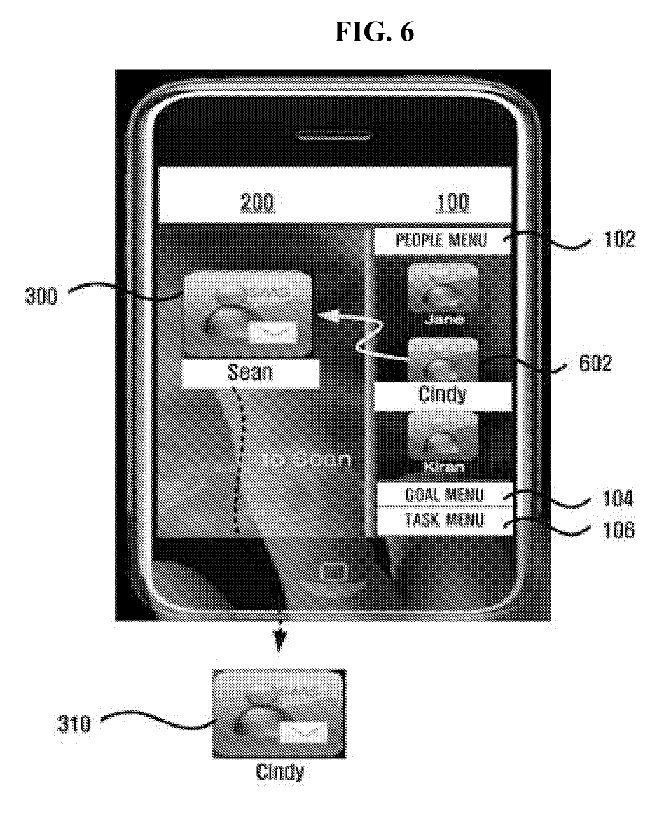

As shown in FIG. 6, the user selects an object “Cindy” 602 from the people menu 102 displayed on the first display screen 100 and drops the selected object, i.e., Cindy 602 onto the corresponding UI 300. Then, the target person is automatically switched from Sean to Cindy and a new UI 310 is created accordingly. In this way, the construction of the macro command is made simple.

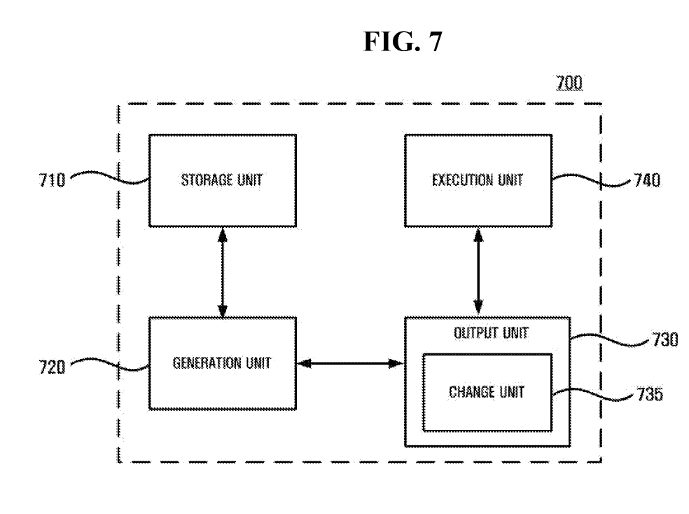

FIG. 7 is a block diagram of a macro generator according to an embodiment of the present invention.

The macro generator 700 includes a storage unit 710, a generation unit 720, an output unit 730 and an execution unit 740. The macro generator 700 may be implemented as a mobile terminal, but it is not limited thereto. That is, the macro generator 700 may be applied to devices performing a user's desired function as the user selects a predetermined object to perform the function. For example, the macro generator 700 can be applied to a mobile phone, a PDA, an MP3 player, a computer, a digital TV, and so on.

The storage unit 710 stores commands corresponding to the user's selected objects. In addition, the storage unit 710 may store macro commands created by a generation unit 720 (described later). In more detail, if the user's terminal has a single display screen, the commands corresponding to the user's selected objects may be stored in the storage unit 710. Alternatively, if the user's terminal has a plurality of display screens, e.g., a first display screen and a second display screen, the user switches an object selected from the first display screen to the second display screen, the command corresponding to the switched object may be stored in the storage unit 710. The storage unit 710 may be a chip-type storage device, such as RAM, DRAM, flash memory, or the like. The commands stored in the storage unit 710 may be created as a macro command by the generation unit 720 (described later).

The generation unit 720 creates a UI (User Interface) representing a macro command, which is a combination of commands corresponding to the respective objects. The UI has at least one format of an image, a moving image, or an icon. In detail, when the plurality of objects selected from the first display screen move to the second display screen, the generation unit 720 may create a macro command using the commands corresponding to the respective objects in response to a predetermined input signal. Here, the created macro command is displayed on the screen in the form of a predetermined UI through the output unit 730 (described later).

The first display screen and the second display screen may be implemented as a touch screen. The macro command may be a combination of commands corresponding to the objects having sequentially moved from the first display screen to the second display screen. If the screen is constructed of a single display screen, the commands corresponding to the user's selected objects may be automatically created as a single macro command in an order in which the commands corresponding to the user's selected objects are selected.

Further, when the user positions a predetermined object on the created UI by a drag & drop method, which is described above with reference to FIG. 6, the generation unit 720 may reconstruct the macro command for the corresponding UI using a command corresponding to the predetermined object. In more detail, if the object positioned on the UI is categorized as the people menu, a command (e.g., A2) contained in the same menu category as the predetermined object, that is, the people menu, can be retrieved from a macro command (e.g., A2+A3+A4) of the previously created UI, so that the command A2 may be replaced by the command (e.g., A1) corresponding to the object positioned on the UI, thus creating a new command (e.g., A1+A3+A4). In addition, the command A1 of the object positioned on the UI may further be added to a previously created macro command (e.g., F1+F2+F3) according to the construction of the UI, creating a new reconstructed macro command (i.e., F1+F2+F3+A1).

The output unit 730 displays the UI executing a macro command function on a screen. As described above, the screen may be constructed of a single display screen or a plurality of display screens, for example, a first display screen having a plurality of objects and a second display screen on which the macro command is created. The output unit 730 may be an image signal display device, such as an LCD (Liquid Crystal Display), a PDP (Plasma Display Panel), an LED (Light-Emitting Diode), an OLED (Organic Light Emitting Diodes), or the like. Here, the output unit 730 may comprise a change unit 735 changing at least one of a size, a shape and a color of the UI according to the frequency of use or the significance level preset by the user.

For example, the change unit 735 may vary the size of the UI according to the number of times the UI is clicked on. In addition, in a case where the macro command is a combination of commands for providing real-time information, e.g., weather information, exchange rate information, or the like, the shape or information of the UI may vary according to the real-time information change. The user is able to identify detailed information on a real-time basis by clicking on the UI.

When one of the UIs displayed on the screen is selected, the execution unit 740 executes a macro command corresponding to the selected UI. Here, the macro command may be comprised of commands sequentially combined in an order in which the objects are selected by the user. Thus, the commands forming the macro command can be executed according to the combined order of the commands, allowing the user to attain his/her desired result without the need for performing a complicated menu selection procedure, details of which are the same as described above with reference to FIGS. 1 through 6.

Various components shown in FIG. 7 may be implemented as a module. The term “module” means, but is not limited to, a software or hardware component, such as a Field Programmable Gate Array (FPGA) or Application Specific Integrated Circuit (ASIC), which performs certain tasks. A module may advantageously be configured to reside on the addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules.

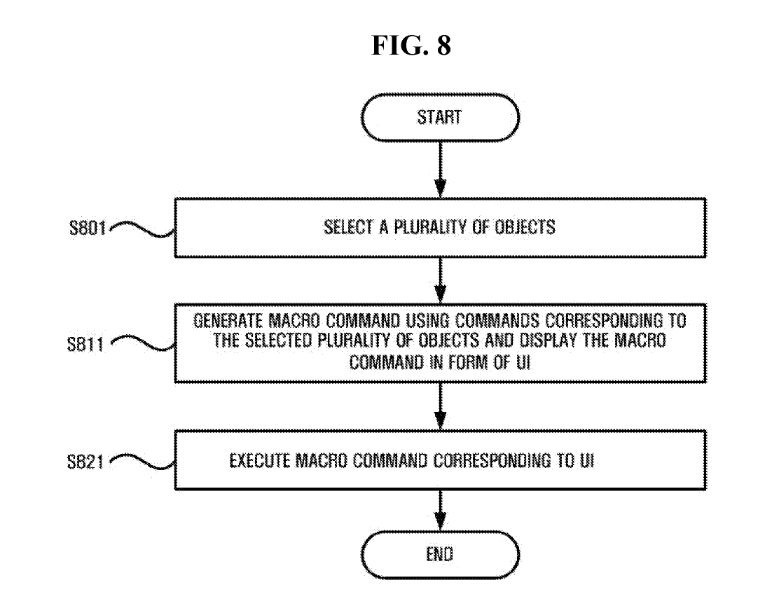

FIG. 8 is a flowchart illustrating a method for creating a macro according to an embodiment of the present invention.

First, the user selects a plurality of objects from a first display screen and drags the selected objects onto a second display screen (S801). In the case where a screen of the current embodiment is constructed of a single display screen in the same manner as in the previous embodiment, the selecting of the plurality of objects may comprise simply selecting the plurality of objects from the display screen, without having to move the objects by a drag & drop method.

In operation S811, the user creates a macro command by combining commands corresponding to the respective objects having moved to the second display screen to then display the macro command in the form of a predetermined UI on the second display screen. Here, the macro command may be comprised of commands combined in an order in which the commands have sequentially moved from the first display screen to the second display screen.

When the user clicks on a predetermined UI among UIs displayed on the screen, the macro command corresponding to the predetermined UI is executed (S821), details of which are the same as described above with reference to FIGS. 1 through 6.

The apparatus and method for creating a macro according to the present invention provides at least the following advantages.

First, a desired function can be easily executed without the need for performing a complicated menu-selection procedure.

Second, a user can easily create a macro command using a combination of a plurality of commands.

Third, since the shape of a UI representing a macro command varies according to the frequency of use or the significance level preset by the user, the user can easily and conveniently achieve his/her desired result through the macro command created in the form of the UI.

Fourth, the user can determine the feasibility of a macro command function based on at least one of the size, shape, and color of the UI.

While the present invention has been particularly shown and described with reference to exemplary embodiments thereof, it will be understood by those of ordinary skill in the art that various changes may be made in the form and details without departing from the spirit and scope of the present invention as defined by the following claims. It is therefore desired that the present embodiments be considered in all respects as illustrative and not restrictive, reference being made to the appended claims rather than the foregoing description to indicate the scope of the invention.

What is claimed is:

1. An apparatus for creating a macro comprising:
a generation unit which generates a user interface (UI) that performs a function of a macro command created by combining macro commands corresponding to a plurality of objects; and
an output unit which displays the UI on a screen.

2. The apparatus of claim 1, wherein the screen includes a first display screen having the plurality of objects and a second display screen on which the macro command is created.

3. The apparatus of claim 2, wherein if the plurality of objects are selected from the first display screen and moved to the second display screen, the generation unit generates commands corresponding to the plurality of objects as the macro command.

4. The apparatus of claim 2, wherein the first display screen and the second display screen are implemented as touch screens that receive input signals.

5. The apparatus of claim 2, wherein the macro command is a combination of commands corresponding to objects that have been moved sequentially from the first display screen to the second display screen.

6. The apparatus of claim 2, wherein the output unit comprises a change unit which changes at least one of a size, shape and color of the UI according to a frequency of use or a significance level preset by a user.

7. The apparatus of claim 6, wherein the change unit changes at least one of a size, shape, and color of the UI according to whether the macro command is feasible.

8. The apparatus of claim 1, wherein if a predetermined object is positioned on the UI, the generation unit reconstructs the macro command using the command corresponding to the predetermined object.

9. The apparatus of claim 1, wherein a plurality of UIs are displayed on the screen and wherein the apparatus further comprises an execution unit which executes a macro command corresponding to a UI selected from the plurality of UIs.

10. A method of forming a macro, comprising:
generating a user interface (UI) which performs a function of a macro command created by combining macro commands corresponding to a plurality of objects; and
displaying the UI on a screen.

11. The method of claim 10, wherein the screen includes a first display screen having the plurality of objects and a second display screen on which the macro command is created.

12. The method of claim 11, wherein if the plurality of objects are selected from the first display screen and are moved to the second display screen, the generating of the UI comprises generating the commands corresponding to the plurality of objects as the macro command.

13. The method of claim 11, wherein the first display screen and the second display screen are implemented as touch screens that receive input signals.

14. The method of claim 11, wherein the macro command is a combination of commands corresponding to objects sequentially moved from the first display screen to the second display screen.

15. The method of claim 10, further comprising changing at least one of a size, shape, and color of the UI according to a frequency of use or a significance level preset by a user.

16. The method of claim 10, further comprising changing at least one of a size, shape, and color of the UI according to whether the macro command is feasible.

17. The method of claim 10, further comprising: if a predetermined object is positioned on the UI, reconstructing the macro command using the command corresponding to the predetermined object.

18. The method of claim 10, further comprising: if the UI displayed on either the first display screen or the second display screen is selected, an execution unit executing a macro command corresponding to the selected UI.
